(19) United States
(12) Patent Application Publication
(10) Pub. No.: US 2023/0093733 A1
(43) Pub. Date: Mar. 23, 2023

(54) AUTOMATIC MASSAGE PORTABLE MASSAGE TABLE

(71) Applicant: Jiangsu Mingteng Health Products Co., Ltd, Yancheng (CN)

(72) Inventor: Chuankui Du, Jinshan (CN)

(73) Assignee: Jiangsu Mingteng Health Products Co., Ltd, Yancheng (CN)

(21) Appl. No.: 18/073,587

(22) Filed: Dec. 2, 2022

(30) Foreign Application Priority Data
Sep. 16, 2022 (CN) 202222466952.5

(51) Int. Cl. A61G 13/00; A61G 13/10; A61G 13/12; A61H 9/00

(52) U.S. Cl. CPC A61G 13/009; A61G 13/105; A61G 13/121; A61H 9/0078; A61H 2201/0138; A61H 2201/0157; A61H 2201/0161; A61H 2201/1654; A61H 2201/1607; A61H 2203/0456; A61H 2203/0468; A61H 2205/084; A61H 2205/04; A61H 2205/081; A61H 2205/083; A61H 2201/1246; A61H 2201/5056; A61H 2201/503; A61G 2200/327; A61G 2200/325

(57) ABSTRACT

An automatic massage portable massage table, and belongs to the technical field of massage apparatuses. The automatic massage portable massage table includes a rigid planner surface, a cushioned pad, an upholstery cover, table legs, long leg supports, short leg supports, a cable system, a headrest cradle, a headrest cushion, and a plurality of airbags. According to the automatic massage portable massage table of the present disclosure, a user can command a circuit board to supply power to an air pump and a plurality of air valves through buttons of a controller. After being powered on, the air pump supplies air to the air valves. Meanwhile, the circuit board controls, according to a pre-stored program, the air valves to achieve air supply and air release, thus controlling the airbags to be inflated and deflated.

### TECHNICAL FIELD

The present disclosure relates to the technical field of massage apparatuses, in particular, to an automatic massage portable massage table.

### BACKGROUND

Existing portable massage tables are well known in the prior art. Massage tables include a sectioned mattress with a foldable base and folding legs. As such, they are well suited for masseuses and therapist who serve clients at various locations. However, such tables lack an important function that the table itself offers massage to a client. Specially, when a client lays in a prone position, masseuses can massage the waist and back of the client, but cannot massage the chest and abdomen of the client. When the client lays in a supine position, masseuses can massage the chest and abdomen of the client, but cannot massage the waist and back of the client.

### SUMMARY

The present disclosure is to provide a massage table and aims to solve the following problem: When a client lays in a prone position, a masseuse cannot massage the chest and abdomen of the client; and when the client lays in a supine position, the masseuse cannot massage the waist and back of the client. By means of adding airbags within a cushioned pad, the chest and abdomen of the client can be massaged when the client lays in the prone position, and the neck, back, waist and hips of the client can be massaged when the client lays in the supine position.

In order to achieve the foregoing objects, the present disclosure provides the following technical solution:

An automatic massage portable massage table includes:

a sectioned rigid planner surface, divided into a left rigid planner surface and a right rigid planner surface, in between, a hinge is mounted, wherein the two sections can rotate inwards around the hinge and allow the portable table to fold;

a cushioned pad, divided into a left cushioned pad and a right cushioned pad placed over the left rigid planner surface and the right rigid planner surface, where said cushioned pad folds along with said sectioned rigid planner surface;

an upholstery cover, divided into a left upholstery cover and a right upholstery cover, upholstered on the left cushioned pad and the right cushioned pad;

four table legs are rotatably mounted to two left side corners of the left rigid planner surface and two right side corners of the right rigid planner surface, where four table legs are away from each other;

four long leg supports, one end of each, rotatably mounted to the left and right rigid planner surfaces close to where the left and right rigid planner surfaces are connected; and the other end of each, rotatably mounted to a short leg support;

four short leg supports, one end of each, rotatably mounted to one long leg support, and the other end of each, rotatably mounted to a lower part of one table leg.

a cable system, with multiple mounting points, by the mounting points, mounted to four corners of the portable massage table, the connection parts of long leg supports and short leg supports, wherein when the portable massage table opens up, the cable system is tensed, and the long leg supports and short leg supports are fixed to support the central area of portable massage table; the cable system can ensure the central area of the portable massage table will not collapse; when the portable massage table is folded, the cable system is in a slack and soft state for convenient folding;

a headrest cradle, mounted at one end of the rigid planner surface, corresponding to client's head when the client lies on the table;

a headrest cushion, mounted on the headrest cradle; and

a plurality of airbags, placed between the cushioned pad and the upholstery cover.

In a further technical solution, each airbag is provided with an air inlet and outlet hose, and each air inlet and outlet hose is connected with an air valve

In a further technical solution, the airbags are placed at positions corresponding to client's neck, waist and back areas when the client lays in a supine position, and at positions corresponding to the chest, abdomen and lower abdomen areas when the client lays in a prone position.

In a further technical solution, the automatic massage portable massage table further includes:

a plurality of air valves, mounted below the rigid planner surface and respectively connected to the multiple airbags through the air inlet and outlet hose; and

an air pump, mounted below the rigid planner surface, wherein the air pump is connected to the air valves through the air inlet and outlet hoses to supply air to the air valves through the air inlet and outlet hoses.

In a further technical solution, the automatic massage portable massage table further includes:

a circuit board, connected to the air pump and the air valves through wires and used for supplying power to the air pump and the air valves; and

a transformer, connected to an external power supply, wherein the transformer is connected to the circuit board through a wire to supply power to the circuit board.

In a further technical solution, the automatic massage portable massage table further includes:

a controller, connected to the circuit board through a wire, wherein the controller is provided with buttons; the buttons are in communication connection with the circuit board through a wire; and

the circuit board is controlled by controlling the buttons.

In a further technical solution, a container is mounted below the rigid planner surface, and the air pump, the air valves and the circuit board are all mounted inside the container.

In a further technical solution, a working program is pre-stored in the circuit board; and the circuit board controls, according to the pre-stored program by means of powering on or powering off the air pump or the air valves, the air pump to pump or stop pump air and the opening, closing and air release of the air valves.

In a further technical solution, when the automatic massage portable massage table is folded, the table legs can be rotated towards the hinge around the connection part of the table legs and the rigid planner surface; the short leg supports can be rotated around the connection part of the short leg supports and the table legs; the long leg supports and the short leg supports can be rotated around the connection part thereof; the long leg supports can be rotated around the-connection part of the long leg support and the rigid planner surface, so that the table legs, the long leg supports and the short leg supports are all folded to a position parallel and close to a bottom of the rigid planner surface; and the left rigid planner surface and the right rigid planner surface can be folded through the hinge in between, so that the automatic massage portable massage table is completely folded.

Compared with the prior art, the present disclosure has the beneficial effects: the automatic massage portable massage table can be used as an ordinary massage table. Furthermore, when a masseuse massages a client, the masseuse or client can command the circuit board to start the automatic massage program through pressing buttons of the controller. According to the pre-stored program, the circuit board controls the air pump to pump air and supply air to the air valves, and, control air valves are to deliver air or stop deliver air to airbags or bleed the airbags, thus controlling the airbags to be inflated and deflated. The multiple airbags are respectively inflated and deflated to wave, and the raised airbags massage the client's body.

### BRIEF DESCRIPTION OF THE DRAWINGS

FIG. 1 is a top view of an automatic massage portable massage table;

FIG. 2 is a flat view of an automatic massage portable massage table;

FIG. 3 is a schematic three-dimensional diagram of a top of an automatic massage portable massage table;

FIG. 4 is a schematic three-dimensional diagram of a bottom of an automatic massage portable massage table;

FIG. 5 is a schematic diagram of an air path and a circuit of an automatic massage portable massage table; and

FIG. 6 is a schematic diagram of a folded effect of an automatic massage portable massage table.

In the drawings: 1: rigid planner surface; 2: cushioned pad; 3: container; 4: airbag; 5: air valve; 6: air pump; 7: short leg support; 8: transformer; 9: controller; 10: circuit board; 11: button; 12: upholstery cover; 13: air inlet and outlet hose; 14: long leg support; 15: hinge; 16: table leg; 17: cable system; 18: headrest cushion; and 19: headrest cradle.

### DETAILED DESCRIPTION OF THE EMBODIMENTS

The technical solutions in the embodiments of the present disclosure will be described clearly and thoroughly below in combination with the accompanying drawings in the embodiments of the present disclosure.

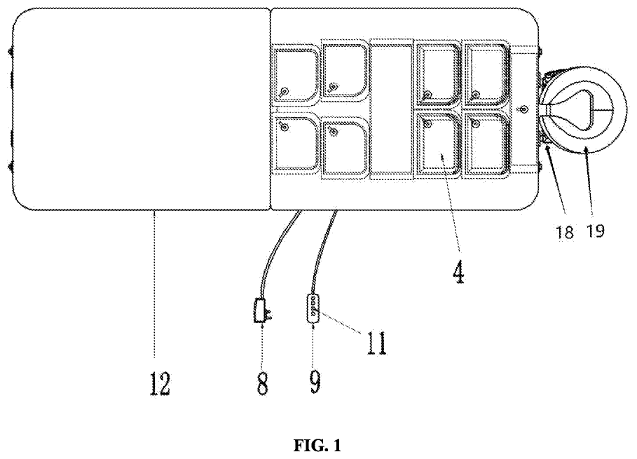

The embodiment of the present disclosure is achieved below. An automatic massage portable massage table as shown in FIG. 1 to FIG. 4 includes:

a sectioned rigid planner surface 1, a cushioned pad 2, and an upholstery cover 12. The sectioned rigid planner surface 1 is divided into a left rigid planner surface and a right rigid planner surface. Two hinges 15 is mounted at center connection positions of the left and right rigid planner surface 1. The sectioned rigid planner surface 1 may rotate inwards around the hinges 15 and make the portable massage table fold. The cushioned pad 2 is divided into a left cushioned pad 2 and a right cushioned pad 2 placed over the left rigid planner surface 1 and the right rigid planner surface 1, where the cushioned pad 2 is folded along with the sectioned rigid planner surface 1. The upholstery cover 12 is divided into a left upholstery cover 12 and a right upholstery cover 12, and is upholstered on the left cushioned pad 2 and the right cushioned pad 2.

As shown in FIG. 1 to FIG. 4, the automatic massage portable massage table further includes four table legs 16, four long leg supports 14, and four short leg supports 7. A table leg 16 is rotatably mounted at each of two outer ends of the left and right rigid planner surfaces 1. One end of each long leg support 14 is rotatably connected to positions of the left and right rigid planner surfaces close to the hinges 15. The other end of each long leg support 14 is rotatably connected to one end of a short leg support 7. The other end of each short leg support 7 is rotatably connected to a lower part of a table leg 16.

As shown in FIG. 1 to FIG. 4, the automatic massage portable massage table further includes a cable system 17. The cable system 17 is divided into two cables 17. Each cable 17 crosses over the left and right rigid planner surfaces 1. Each cable 17 is provided with four mounting points. The mounting points on two ends of each cable 17 are mounted to upper parts of the table legs 16 on both sides of the portable massage table. The mounting points on the middle area of each cable 17 are mounted to the connection parts of the short leg supports 7 and long leg supports 14 on both sides of the massage table. When the portable massage table opens up, the cable system 17 is tensed, the position and angle of the short leg supports 7 and the long leg supports 14 are fixed to support the central area of the portable massage table, so that the cable system 17 can ensure the central area of portable massage table will not collapse. When the portable massage table is folded, the cable system 17 is in a slack and soft state for convenient folding.

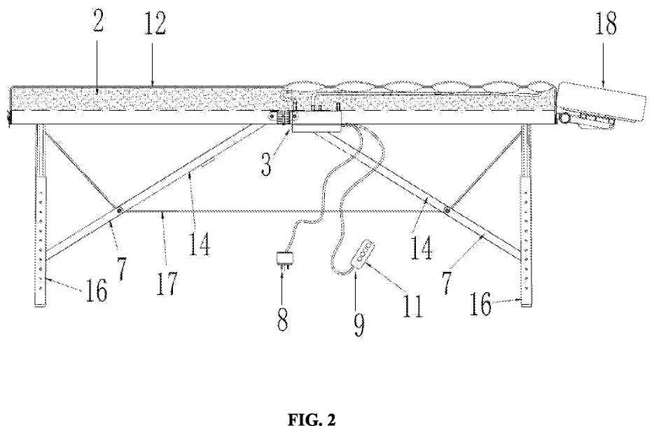

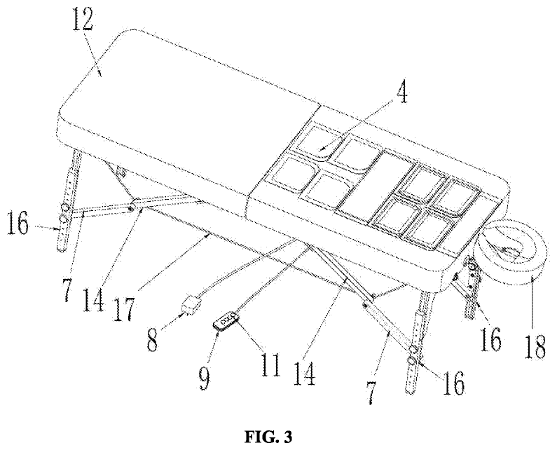

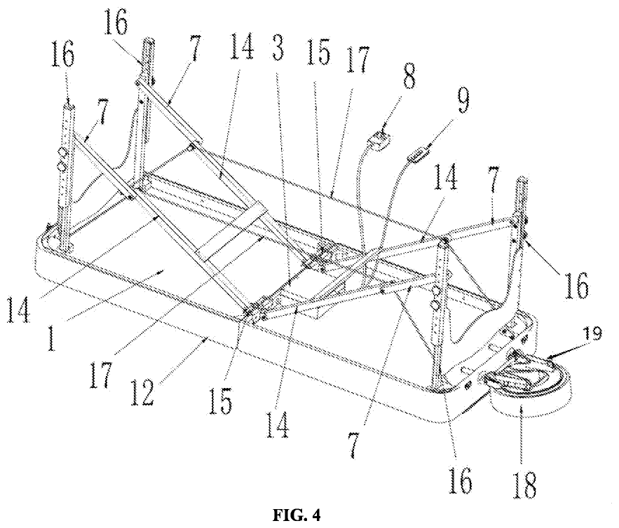

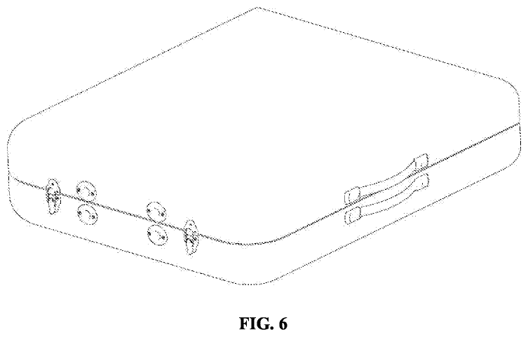

As shown in FIG. 2, FIG. 3, FIG. 4, and FIG. 6, when the automatic massage portable massage table is folded, the table legs 16 may rotate towards the hinge 15 around the connection parts of the table legs 16 and the rigid planner surface 1. The short leg supports 7 may rotate around the connection parts of the short leg supports 7 and the table legs 16. The long leg supports 14 and the short leg supports 7 may rotate around the connection parts thereof. The long leg supports 14 may rotate around the connection parts of the long leg supports 14 and the rigid planner surface 1. By the above rotating manner, the table legs 16, the long leg supports 14 and the short leg supports 7 all rotate to be folded to a position close to the bottom of the rigid planner surfaces 1. The left rigid planner surface 1 and the right rigid planner surface 1 are folded through the hinge 15, so that the automatic massage portable massage table is completely folded like a suitcase.

As shown in FIG. 1 to FIG. 4, the automatic massage portable massage table further includes a detachable headrest cushion 18 and a headrest cradle 19.

As shown in FIG. 1 to FIG. 4, a plurality of airbags 4 are fixed in an interlayer between the cushioned pad 2 and the upholstery cover 12. Each airbag 4 is provided with an air inlet and outlet hose 13. The plurality of airbags 4 can be respectively independently inflated or deflated through the plurality of air inlet and outlet hoses 13.

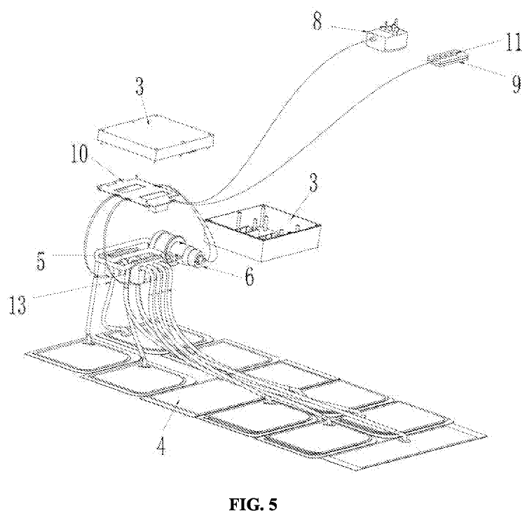

As shown in FIG. 1 to FIG. 5, one embodiment of the present disclosure further includes a container 3, a plurality of air valves 5, an air pump 6, a transformer 8, and a circuit board 10. The container 3 is mounted below the rigid planner surface 1. The air valves 5, the air pump 6 and the circuit board 10 are mounted inside the container 3. The air pump 6 and the air valves 5 are connected through the air inlet and outlet hose 13. The air pump 6 supplies air to the air valves 5 through the air inlet and outlet hoses 13. Each air valve 5 is connected to one or more airbags 4 through the air inlet and outlet hose 13. The airbags 4 are inflated, held and deflated by means of opening, closing and air release of the air valves 5, thus forming a complete air loop.

In the present disclosure, after the air pump 6 is powered on, gas in air can be sucked, and the gas is conveyed to the air valves 5 through the air inlet and outlet hose 13. Electromagnetic valves are mounted inside the air valves 5. The opening, closing and air release functions of the air valves 5 can be realized by means of powering on and powering off the air valves 5. The air valves 5 and the airbags 4 are connected through the air inlet and outlet hoses 13, so that the air valves 5 control the airbags 4 to be inflated, held and deflated.

As shown in FIG. 1 to FIG. 5, the transformer 8 is connected to an external power supply, and can convert a high voltage of 110-230 V into a safe voltage lower than 36 V. The transformer 8 is connected with the circuit board 10 through a wire and supplies power to the circuit board 10. The circuit board 10 is connected to the air pump 6 and the air valves 5 through wires and supplies power to the air pump 6 and the air valves 5, thus forming a complete power supply loop.

In the present disclosure, a working program is pre-stored in the circuit board 10. By means of powering on or powering off the air pump 6 or the air valves 5 according to the preset program, the circuit board 10 controls the air pump 6 to pump air or controls the opening, closing and air release of the air valves 5, thus inflating, holding and deflating the airbags 4.

As shown in FIG. 1 to FIG. 5, in the present disclosure, the automatic massage portable massage table further includes a controller 9. The controller 9 is connected with the circuit board 10 through a wire. The controller 9 is provided with buttons 11. The buttons 11 are in communication connection with the circuit board 10 through a wire. The circuit board 10 is controlled by means of controlling the buttons 11.

In the present disclosure, a user operates the buttons 11 of the controller 9 to send a working instruction to the circuit board 10. The circuit board 10 controls, according to the pre-stored program by means of powering on or powering off the air pump 6 or the air valves 5, the air pump 6 to pump air and the opening, closing and air release of the air valves 5, thus inflating, holding and deflating the airbags 4.

In the present disclosure, the airbags 4 are inflated to rise, so that the upholstery cover 12 rises to massage a user lying on the automatic massage portable massage table.

In the present disclosure, when the client lays in a prone position on the automatic massage portable massage table, a masseuse can control, through the buttons 11 of the controller 9, the circuit board 10 to enable a massage function to client's chest and the abdomen while the masseuse massages the back and the legs of the client, and the chest and the abdomen of the client are massaged by means of inflating, holding and deflating the airbags 4. When the client lays in a supine position on the automatic massage portable massage table, the masseuse can control, through the buttons 11 of the controller 9, the circuit board 10 to enable a massage function to client's neck, back, waist and hips while the masseuse massages the arms, chest and the abdomen of the client, and the neck, back, waist and the hips of the client are massaged by means of inflating, holding and deflating the airbags 4.

The specific embodiments discussed in the detailed description are merely illustrative of specific ways to make and use the invention, and do not limit the scope of the invention.

What is claimed is:

1. An automatic massage portable massage table, comprising:
a rigid planner surface, divided into a left rigid planner surface and a right rigid planner surface, between which a hinge is mounted, wherein the left and right rigid planner surface may inwards rotate around the hinge in order to allow the portable massage table to fold;
a cushioned pad, divided into a left cushioned pad and a right cushioned pad placed over the left rigid planner surface and the right rigid planner surface, wherein the cushioned pad is folded along with the sectioned rigid planner surface;
an upholstery cover, divided into a left upholstery cover and a right upholstery cover, and upholstered on the left-cushioned pad and the right cushioned pad;
four table legs, rotatable mounted to two left side corners of the left rigid planner surface and two right side corners of the right rigid planner surface, where four table legs are away from each other;
four long leg supports, one end of each, rotatable mounted to the left and right rigid planner surfaces close to where the left and right rigid planner surfaces are connected; the other end end of each long leg support rotatable mounted to a short leg support;
four short leg supports, one end of each, rotatable mounted to one long leg support, and the other end of each short leg support, rotatable mounted to a lower part of a table leg;
a cable system, provided with multiple mounting points, wherein the left and right mounting points are respectively connected to upper parts of the left and right table legs; the two middle mounting points are respectively connected to a joint part of the short leg supports and long leg supports on the left side and joint parts of the short leg supports and long leg supports on the right side.
a headrest cradle, mounted at one end of the rigid planner surface, corresponding to a client's head when the client lies on the table;
a headrest cushion, mounted on the headrest cradle; and
a plurality of airbags, placed between the upholstery cover and the cushioned pad.

2. The automatic massage portable massage table according to claim 1, wherein each airbag is provided with an air inlet and outlet hose, and each air inlet and outlet hose is connected with an air valve.

3. The automatic massage portable massage table according to claim 1, wherein the airbags are placed at positions corresponding to client's neck, waist and back areas when the client lays in a supine position, and at positions corresponding to the chest, abdomen and lower abdomen areas when the client lays in a prone position.

4. The automatic massage portable massage table according to claim 1, wherein the automatic massage portable massage table further comprises:
a plurality of air valves, mounted below the rigid planner surface and respectively connected to the plurality of airbags through the air inlet and outlet hoses; and
an air pump, mounted below the rigid planner surface, wherein the air pump is connected to the air valves through the air inlet and outlet hoses to supply air to the air valves through the air inlet and outlet hoses.

5. The automatic massage portable massage table according to claim 4, wherein the automatic massage portable massage table further comprises:
a circuit board, connected to the air pump and the air valves through wires and used for supplying power to the air pump and the air valves; and
a transformer, connected to an external power supply, wherein the transformer is connected to the circuit board through a wire to supply power to the circuit board.

6. The automatic massage portable massage table according to claim 5, wherein the automatic massage portable massage table further comprises:
a controller, connected to the circuit board through a wire, wherein the controller is provided with buttons; the buttons are in communication connection with the circuit board through a wire; and
the circuit board is controlled by controlling the buttons.

7. The automatic massage portable massage table according to claim 5, wherein a container is mounted below the rigid planner surface, and the air pump, the air valves and the circuit board are all mounted inside the container.

8. The automatic massage portable massage table according to claim 5, wherein a working program is pre-stored in the circuit board; and the circuit board controls, according to the pre-stored program by means of powering on or powering off the air pump or the air valves, the air pump to pump air or the opening, closing and air release of the air valves.

9. The automatic massage portable massage table according to claim 1, wherein the table legs rotate around the connection parts of the table legs and the rigid planner surfaces, the short leg supports rotate around the connection parts of the short leg supports and the table legs; the long leg supports and the short leg supports rotate around the connection parts thereof; the long leg supports rotate around the connection parts of the long leg supports and the rigid planner surfaces.
